(19) United States
(12) Patent Application Publication
(10) Pub. No.: US 2017/0261726 A1
(43) Pub. Date: Sep. 14, 2017

(54) IMAGING LENS AND IMAGE CAPTURING DEVICE

(71) Applicant: Nikon Corporation, Tokyo (JP)

(72) Inventor: Atsushi SEKINE, Kasukabe-shi (JP)

(21) Appl. No.: 15/605,670

(22) Filed: May 25, 2017

Related U.S. Application Data
(63) Continuation of application No. PCT/JP2014/005968, filed on Nov. 28, 2014.

(51) Int. Cl. G02B 13/00; G02B 9/60

(52) U.S. Cl. CPC G02B 13/0045; G02B 9/60

(57) ABSTRACT

An imaging lens (PL) having an image surface (I) curved to have a concave surface facing an object, the imaging lens comprising five lenses including a positive lens and a negative lens. At least one negative lens in the five lenses is disposed to an image side of a positive lens. A set of the positive lens and the negative lens, as one of sets each including the positive lens and the negative lens disposed to the image side of the positive lens, that has largest positive refractive power as combined refractive power, satisfies a following conditional expression:

0.5<fc/f<1.2, where

fc denotes a combined focal length of the positive lens and the negative lens with the largest positive refractive power as the combined refractive power, and

f denotes a focal length of the imaging lens.

### TECHNICAL FIELD

The present invention relates to an imaging lens suitably used for an image capturing device embedded in a mobile terminal or the like.

### TECHNICAL BACKGROUND

Imaging lenses (see, for example, Patent Document 1) used in small image capturing devices embedded in mobile terminals or the like are required to have high resolving power of about 1 to 2 μm on an imaging surface, due to development of image sensors with increased pixels. The imaging lenses are also required to have a shorter entire length due to reduced thickness of mobile terminals or the like. The high resolving power may be achieved by an imaging lens having an aspherical lens surface. Thus, almost all the lens surfaces of conventional imaging lenses used in small image capturing devices are aspherical. Another possible solution is to increase the number of lens to achieve the imaging lens with high resolving power. Logically, the increased number of lenses simply leads to a larger space required for the lenses to be inserted, and thus results in a longer length of the entire imaging lens.

### PRIOR ARTS LIST

### Patent Document

Patent Document 1: WO2013/027641(A1)

### SUMMARY OF THE INVENTION

### Problems to be Solved by the Invention

As described above, the conventional imaging lenses have had room for improvement to achieve an imaging lens having short entire length and a high imaging performance.

The present invention is made in view of the above, and an object of the present invention is to provide an imaging lens having a short entire length and a favorable imaging performance and to provide an image capturing device using the same.

### Means to Solve the Problems

To achieve this object, an imaging lens according to a first aspect of the present invention has an image surface curved to have a concave surface facing an object, the imaging lens comprising five lenses including a positive lens and a negative lens. At least one negative lens in the five lenses is disposed to an image side of a positive lens. A set of the positive lens and the negative lens, as one of sets each including the positive lens and the negative lens disposed to the image side of the positive lens, that has largest positive refractive power as combined refractive power, satisfies a following conditional expression.

0.5<fc/f<1.2, where

fc denotes a combined focal length of the positive lens and the negative lens with the largest positive refractive power as the combined refractive power, and

f denotes a focal length of the imaging lens.

An imaging lens according to a second aspect of the present invention has an image surface curved to have a concave surface facing an object, the imaging lens comprising in order from the object: a first lens having lens surfaces on both sides curved to have convex surfaces facing the object; a second lens having positive refractive power; a third lens having negative refractive power; a fourth lens having positive refractive power or negative refractive power; and a fifth lens having positive refractive power or negative refractive power. A following conditional expression is satisfied.

0.5<f23/f<1.2, where

f23 denotes a combined focal length of the second lens and the third lens, and

f denotes a focal length of the imaging lens.

An image capturing device according to the present invention comprises: an imaging lens with which an image of an object is formed on an imaging surface; and an image sensor configured to obtain the image of the object formed on the imaging surface. The imaging lens comprises five lenses including a positive lens and a negative lens. At least one negative lens in the five lenses is disposed to an image side of a positive lens. A set of the positive lens and the negative lens, as one of sets each including the positive lens and the negative lens disposed to the image side of the positive lens, that has largest positive refractive power as combined refractive power, satisfies a following conditional expression.

0.5<fc/f<1.2, where

fc denotes a combined focal length of the positive lens and the negative lens with the largest positive refractive power as the combined refractive power, and

f denotes a focal length of the imaging lens.

### Advantageous Effects of the Invention

According to the present invention, an imaging lens having a favorable imaging performance and a short entire length can be achieved.

### BRIEF DESCRIPTION OF THE DRAWINGS

FIG. 1 is a diagram illustrating a lens configuration of an imaging lens according to Example 1.

FIG. 2 is graphs illustrating various aberrations of the imaging lens according to Example 1.

FIG. 3 is a diagram illustrating a lens configuration of an imaging lens according to Example 2.

FIG. 4 is graphs illustrating various aberrations of the imaging lens according to Example 2.

FIG. 5 is a diagram illustrating a lens configuration of an imaging lens according to Example 3.

FIG. 6 is graphs illustrating various aberrations of the imaging lens according to Example 3.

FIG. 7 is a cross-sectional view of an image capturing device.

### DESCRIPTION OF THE EMBODIMENTS

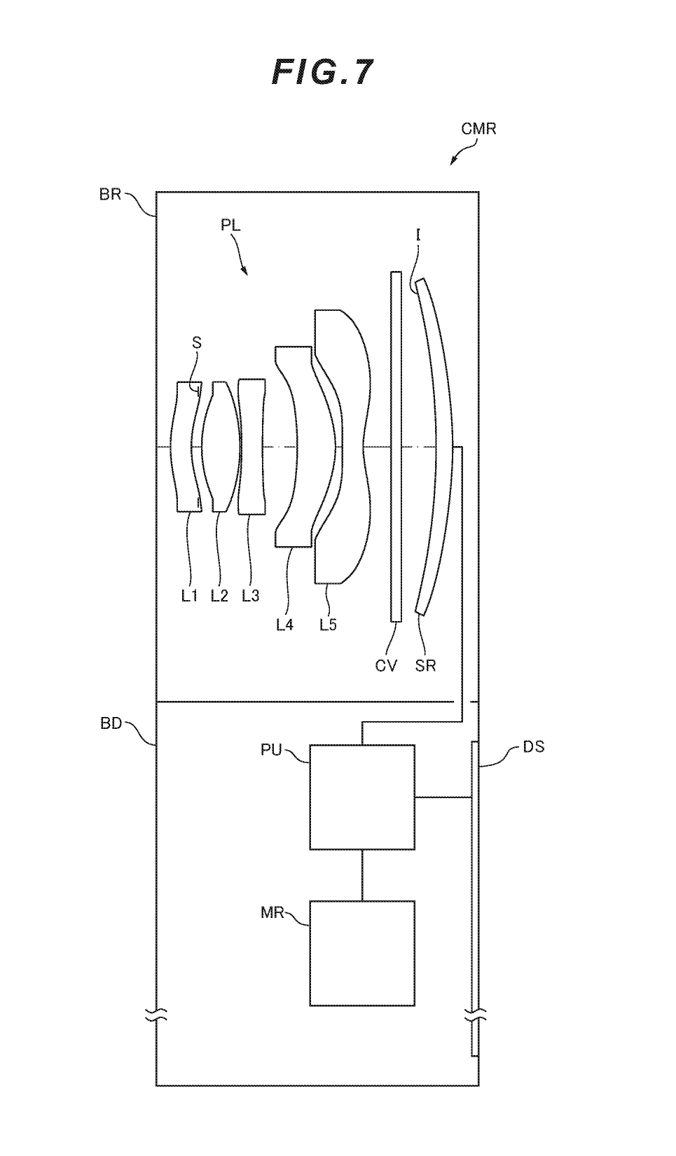

Preferred embodiments of the present application are described below with reference to the drawings. FIG. 7 illustrates an image capturing device CMR including an imaging lens according to the present application. Specifically, FIG. 7 is a cross-sectional view of the image capturing device CMR embedded in a mobile terminal or the like. The image capturing device CMR mainly includes: a barrel BR provided in a device main body BD of the mobile terminal or the like; an imaging lens PL contained and held in the barrel BR; an image sensor SR contained in the barrel BR; and a control unit PU contained in the device main body BD. With the imaging lens PL, an image of a subject (object) is formed on an imaging surface of the image sensor SR.

The image sensor SR includes an image sensor such as a CCD or a CMOS, and is disposed along an image surface I of the imaging lens PL. The image sensor SR has a surface as an imaging surface on which pixels (photoelectric conversion elements) are two-dimensionally formed. The imaging surface of the image sensor SR is curved to have a concave surface facing the object. The imaging lens PL has the image surface I curved along the imaging surface of the image sensor SR. For example, the image sensor SR has the imaging surface as a spherical concave surface or an aspherical concave surface. The image sensor SR photoelectrically converts light from the subject, focused on the imaging surface with the imaging lens PL, and outputs the resultant image data on the subject to the control unit PU or the like.

The control unit PU is electrically connected to: the image sensor SR; an I/O unit DS provided on an outer side of the device main body BD of the mobile terminal or the like; and a storage unit MR contained in the device main body BD. The I/O unit DS, including a touch panel and a liquid crystal panel, executes processing corresponding to an operation (such as an image capturing operation) of a user, displays the subject image obtained by the image sensor SR, or the other like processing. The storage unit MR stores data required for operations of the image sensor SR or the like, and the image data on the subject obtained by the image sensor SR. The control unit PU controls each of the image sensor SR, the I/O unit DS, the storage unit MR, or the like. The control unit PU can execute various types of image processing on the image data on the subject obtained by the image sensor SR.

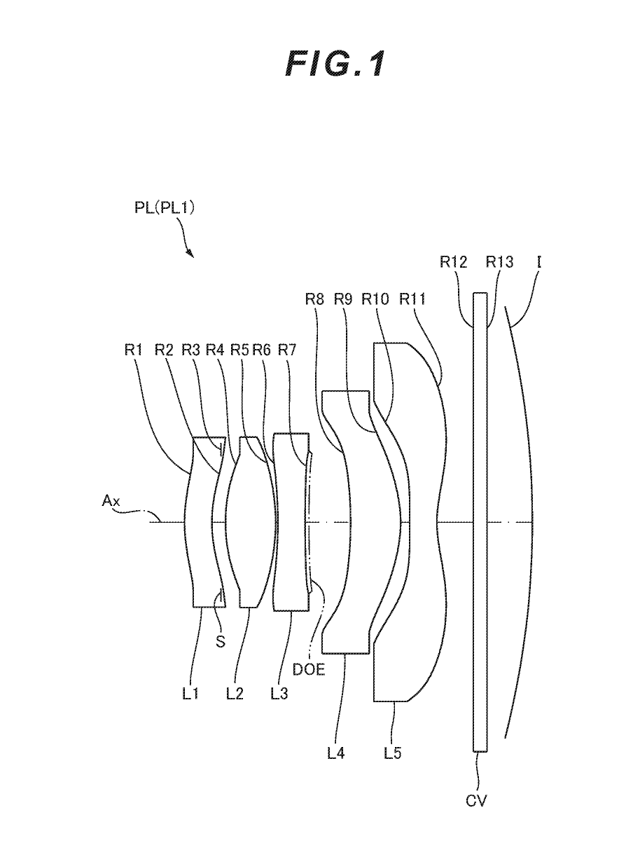

An imaging lens PL according to a first embodiment is described. For example, as illustrated in FIG. 1, the imaging lens PL according to the first embodiment includes five lenses L1 to L5 including both a positive lens and a negative lenss, and has the image surface I curved to have the concave surface facing the object. Specifically, the image surface I of the imaging lens PL is curved more largely toward the object, as it gets closer to a peripheral portion from an optical axis Ax. At least one negative lens, in the five lenses L1 to L5, is disposed to an image side of the positive lens. One of a set of the positive lens and the negative lens disposed to the image side of the positive lens that has the largest positive refractive power as combined refractive power (for example, a set of a second lens L2 having the positive refractive power and a third lens L3 having negative refractive power) satisfies a condition indicated by the following conditional expression (1).

0.5<fc/f<1.2 (1)

where, fc denotes a combined focal length of the positive lens and the negative lens with the largest positive refractive power as the combined refractive power, and

f denotes a focal length of the imaging lens PL.

In the present embodiment, the image surface I of the imaging lens PL is curved to have the concave surface facing the object, and thus a load for correcting the curvature of field can be reduced. Thus, a favorable imaging performance can be achieved with a smaller number of lenses and thus with a shorter length of the entire imaging lens PL. The conditional expression (1) is for determining an appropriate range of a relationship between the combined focal length fc of the positive lens and the negative lens with the largest positive refractive power as the combined refractive power and the focal length f of the entire imaging lens PL. A condition with a value that is smaller than the lower limit value of the conditional expression (1) is unfavorable because it results in the combined focal length fc that is excessively short rendering the correction of the curvature of field difficult. Increasing the number of lenses to correct the curvature of field leads to a longer length of the entire imaging lens, resulting in an insufficient back focus. A condition with a value that is larger than the upper limit value of the conditional expression (1) is unfavorable because it results in the combined focal length fc that is excessively long resulting in a long length of the entire imaging lens.

To guarantee the effects of the present embodiment, the lower limit value of the conditional expression (1) is preferably set to be 0.80. To guarantee the effects of the present embodiment, the upper limit value of the conditional expression (1) is preferably set to be 1.10.

The imaging lens PL having the configuration described above preferably satisfies a condition indicated by the following conditional expression (2).

−0.3<SAG/fc<−0.09 (2)

where, SAG denotes an amount of curvature of the image surface I in an optical axis direction at a maximum image height.

The conditional expression (2) is for determining an appropriate range of a relationship between the amount of curvature SAG of the image surface I in the optical axis direction at the maximum image height and the combined focal length fc of the positive lens and the negative lens with the largest positive refractive power as the combined refractive power. A condition with a value that is smaller than the lower limit value of the conditional expression (2) is unfavorable because it results in the combined focal length fc that is excessively short rendering the correction of various aberrations such as a coma aberration difficult. When the amount of curvature SAG of the image surface I in the optical axis direction is too large in a negative direction, a long back focus is required to prevent interference between the last lens and the image sensor, resulting in a long length of the entire imaging lens. A condition with a value that is larger than the upper limit value of the conditional expression (2) is unfavorable because it results in a large load on a lens for correcting the curvature of field when the amount of curvature SAG of the image surface I in the optical axis direction is too small, rendering the correction of the curvature of field difficult. Increasing the number of lenses to correct the curvature of field leads to a longer length of the entire imaging lens. The combined focal length fc that is excessively long is unfavorable because it results in a long length of the entire imaging lens.

To guarantee the effects of the present embodiment, the lower limit value of the conditional expression (2) is preferably set to be −0.20. To guarantee the effects of the present embodiment, the upper limit value of the conditional expression (2) is preferably set to be −0.12.

The imaging lens PL having the configuration described above preferably includes the five lenses L1 to L5 including at least one negative lens formed of an optical material with an Abbe number of 40 or smaller, and satisfies a condition indicated by the following conditional expression (3).

(ra+rb)/(ra−rb)<0 (3)

where, ra denotes a radius of curvature of an object-side lens surface of the negative lens formed of the optical material with an Abbe number of 40 or smaller, and

rb denotes a radius of curvature of an image-side lens surface of the negative lens formed of the optical material with an Abbe number of 40 or smaller.

At least one negative lens formed of the optical material with a small Abbe number is required for correcting a chromatic aberration. The negative lens needs to have a certain level of refractive power to favorably correct the chromatic aberration. The conditional expression (3) is for determining an appropriate range for a shape factor of the negative lens formed of the optical material with an Abbe number of 40 or smaller. A condition with a value that is larger than the upper limit value of the conditional expression (3) results in the negative lens formed of the optical material with an Abbe number of 40 or smaller having the image-side lens surface with a radius of curvature smaller than that of the object-side lens surface. As a result, an upper side light flux of a grazing incidence light flux passes through a position of the image-side lens surface of the negative lens farther from the optical axis Ax than that of the object-side lens surface, and thus is largely refracted on the image-side lens surface. This renders the correction of a coma aberration difficult and results in light falloff at edges, and thus is unfavorable.

To guarantee the effects of the present embodiment, the upper limit value of the conditional expression (3) is preferably set to be −0.30. The negative lens formed of the optical material with an Abbe number of 40 or smaller is preferably a negative lens (for example, the third lens L3 having the negative refractive power) in the set of lenses with the largest positive refractive power as the combined refractive power.

In the imaging lens PL having the configuration described above, a lens (first lens L1), in the five lenses L1 to L5, closest to the object has lens surfaces on both sides curved to have convex surfaces facing the object, and satisfies a condition indicated by the following conditional expression (4).

|f/fa|<0.5 (4)

where, fa denotes a focal length of the lens closest to the object.

The object-side lens surface preferably does not protrude toward the object beyond the center of the lens surface, in terms of keeping the length of the lens short. Thus, the lens closest to the object in the five lenses L1 to L5 needs to have a portion convex toward the object side. The conditional expression (4) is for determining an appropriate range of a relationship between the focal length f of the entire imaging lens PL and the focal length fa of the lens closest to the object. A condition with a value that is larger than the upper limit value of the conditional expression (4) is unfavorable because it leads to a lens more on the image side than an aperture stop S having excessively high negative refractive power when the lens closest to the object has the positive refractive power, rendering the correction of the coma aberration difficult and resulting in light falloff at edges. The lens closest to the object having the negative refractive power is unfavorable because it leads to the back focus that is longer than necessary, resulting in a long length of the entire imaging lens.

To guarantee the effects of the present embodiment, the upper limit value of the conditional expression (4) is preferably set to be 0.25.

The imaging lens PL having the configuration described above preferably satisfies a condition indicated by the following conditional expression (5).

0.5<fp/f<0.7 (5)

where, fp denotes a focal length of a positive lens in the set of lenses with the largest positive refractive power as the combined refractive power.

The conditional expression (5) is for determining an appropriate range of a relationship between the focal length fp of the positive lens of the set of lenses with the largest positive refractive power as the combined refractive power and the focal length f of the entire imaging lens PL. A condition with a value that is smaller than the lower limit value of the conditional expression (5) is unfavorable because it leads to the focal length fp of the positive lens that is excessively short, rendering the correction of various aberrations, such as a spherical aberration and the coma aberration, difficult. A condition with a value that is larger than the upper limit value of the conditional expression (5) is unfavorable because it leads to the focal length fp of the positive lens that is excessively long, resulting in a long length of the entire imaging lens.

To guarantee the effects of the present embodiment, the lower limit value of the conditional expression (5) is preferably set to be 0.55. To guarantee the effects of the present embodiment, the upper limit value of the conditional expression (5) is preferably set to be 0.65.

Preferably, in the imaging lens PL having the configuration described above, a lens (first lens L1), in the five lenses L1 to L5, closest to the object has lens surfaces on both sides curved to have convex surfaces facing the object, and a condition indicated by the following conditional expressions (6) and (7) is satisfied.

−0.12<Y/(Fno×fa)<0.15 (6)

|fa/fc|>5 (7)

where, Y denotes a maximum image height of the imaging lens PL,

Fno denotes an F number of the imaging lens PL, and

fa denotes a focal length of the lens closest to the object.

The conditional expression (6) is for determining an appropriate range of a relationship among the maximum image height Y of the imaging lens PL, the F number Fno of the imaging lens PL, and the focal length fa of the lens closest to the object. A condition with a value that is smaller than the lower limit value of the conditional expression (6) is unfavorable because it leads to the lens closest to the object having excessively high negative refractive power leading to the back focus that is longer than necessary, resulting in a long length of the entire imaging lens. A condition with a value that is larger than the upper limit value of the conditional expression (6) is unfavorable because it leads to a lens more on the image side than the aperture stop S having excessively high negative refractive power when the positive refractive power of the lens closest to the object is large, rendering the correction of the coma aberration difficult and resulting in light falloff at edges.

To guarantee the effects of the present embodiment, the lower limit value of the conditional expression (6) is preferably set to be −0.05. To guarantee the effects of the present embodiment, the upper limit value of the conditional expression (6) is preferably set to be 0.05.

The conditional expression (7) is for determining an appropriate range of a relationship between the focal length fa of the lens closest to the object and the combined focal length fc of the positive lens and the negative lens with the largest positive refractive power as the combined refractive power. A condition with a value that is smaller than the lower limit value of the conditional expression (7) is unfavorable because the combined focal length fc needs to be short when the negative refractive power of the lens closest to the object is excessively large, rendering the correction of the spherical aberration difficult. The condition is unfavorable because an incident angle of a lower side light flux incident on the positive lens in the set of lenses with the largest positive refractive power as the combined refractive power is large when the positive refractive power of the lens closest to the object is excessively large, rendering the correction of the coma aberration difficult.

To guarantee the effects of the present embodiment, the lower limit value of the conditional expression (7) is preferably set to be 10.0.

Preferably, in the imaging lens PL having the configuration described above, a lens (first lens L1), in the five lenses L1 to L5, closest to the object has lens surfaces on both sides curved to have convex surfaces facing the object. For example, as illustrated with a two-dot chain line in FIG. 1, a bonded-multilayer diffractive optical element (DOE) may be provided on a lens surface of at least any one of the lens closest to the object, and the positive lens and the negative lens with the largest positive refractive power as the combined refractive power. With such a configuration, an on-axis chromatic aberration can be successfully corrected. As described above, the first embodiment can achieve a favorable imaging performance with the entire imaging lens PL having a short length.

Next, an imaging lens PL according to a second embodiment is described. The imaging lens PL according to the second embodiment has a configuration similar to that of the imaging lens PL according to the first embodiment, and thus is described with reference numerals that are the same as those in the first embodiment. For example, as illustrated in FIG. 1, the imaging lens PL according to the second embodiment includes: a first lens L1 having lens surfaces on both sides curved to have convex surfaces facing the object; a second lens L2 having positive refractive power; a third lens L3 having negative refractive power; a fourth lens L4 having positive refractive power (or negative refractive power) ; and a fifth lens L5 having negative refractive power (or positive refractive power) which are disposed in order from the object along the optical axis Ax. An image surface I is curved to have a concave surface facing the object. More specifically, the image surface I of the imaging lens PL is curved more toward the object, as it gets closer to the peripheral portion from the optical axis Ax. The imaging lens PL having such a configuration satisfies a condition indicated by the following conditional expression (11).

0.5<f23/f<1.2 (11)

where, f23 denotes a combined focal length of the second lens L2 and the third lens L3, and

f denotes a focal length of the imaging lens PL.

In the present embodiment, the image surface I of the imaging lens PL is curved to have the concave surface facing the object, and thus a load for correcting the curvature of field can be reduced. Thus, a favorable imaging performance can be achieved with a smaller number of lenses and thus with a shorter length of the entire imaging lens PL. The conditional expression (11) is for determining an appropriate range of a relationship between the combined focal length f23 of the second lens L2 and third lens L3 and the focal length f of the entire imaging lens PL. A condition with a value that is smaller than the lower limit value of the conditional expression (11) is unfavorable because it results in the combined focal length f23 that is excessively short rendering the correction of the curvature of field difficult. Increasing the number of lenses to correct the curvature of field leads to a longer length of the entire imaging lens, resulting in an insufficient back focus. A condition with a value that is larger than the upper limit value of the conditional expression (11) is unfavorable because it results in the combined focal length f23 that is excessively long resulting in a long length of the entire imaging lens.

To guarantee the effects of the present embodiment, the lower limit value of the conditional expression (11) is preferably set to be 0.80. To guarantee the effects of the present embodiment, the upper limit value of the conditional expression (11) is preferably set to be 1.10.

The imaging lens PL having the configuration described above preferably satisfies a condition indicated by the following conditional expression (12).

−0.3<SAG/f23<−0.09 (12)

where, SAG denotes an amount of curvature of the image surface I in an optical axis direction at a maximum image height.

The conditional expression (12) is for determining an appropriate range of a relationship between the amount of curvature SAG of the image surface I in the optical axis direction at the maximum image height and the combined focal length f23 of the second lens L2 and the third lens L3. A condition with a value that is smaller than the lower limit value of the conditional expression (12) is unfavorable because it results in the combined focal length f23 that is excessively short rendering the correction of various aberrations such as the coma aberration difficult. When the amount of curvature SAG of the image surface I in the optical axis direction is too large in a negative direction, a long back focus is required to prevent interference between the last lens and the image sensor, resulting in a long length of the entire imaging lens. A condition with a value that is larger than the upper limit value of the conditional expression (12) is unfavorable because it results in a large load on a lens for correcting the curvature of field when the amount of curvature SAG of the image surface I in the optical axis direction is too small, rendering the correction of the curvature of field difficult. Increasing the number of lenses to correct the curvature of field leads to a longer length of the entire imaging lens. The combined focal length f23 that is excessively long is unfavorable because it results in a long length of the entire imaging lens.

To guarantee the effects of the present embodiment, the lower limit value of the conditional expression (12) is preferably set to be −0.20. To guarantee the effects of the present embodiment, the upper limit value of the conditional expression (12) is preferably set to be −0.12.

The imaging lens PL having the configuration described above preferably satisfies a condition indicated by the following conditional expression (13).

(r31+r32)/(r31−r32)<0 (13)

where, r31 denotes a radius of curvature of an object-side lens surface of the third lens L3, and

r32 denotes a radius of curvature of an image-side lens surface of the third lens L3.

At least one negative lens formed of an optical material with a small Abbe number is required for correcting a chromatic aberration. The negative lens needs to have a certain level of refractive power to successfully correct the chromatic aberration. The conditional expression (13) is for determining an appropriate range for a shape factor of the third lens L3 with the negative refractive power. A condition with a value that is larger than the upper limit value of the conditional expression (13) results in the third lens L3 having the image-side lens surface with a radius of curvature smaller than that of the object-side lens surface. As a result, an upper side light flux of a grazing incidence light flux passes through a position of the image-side lens surface of the third lens L3 farther from the optical axis Ax than that of the object-side lens surface, and thus is largely refracted on the image-side lens surface. This renders the correction of the coma aberration difficult and results in light falloff at edges, and thus is unfavorable.

To guarantee the effects of the present embodiment, the upper limit value of the conditional expression (13) is preferably set to be −0.30.

The imaging lens PL having the configuration described above preferably satisfies a condition indicated by the following conditional expression (14).

|f/f1|<0.5 (14)

where, fl denotes a focal length of the first lens L1.

The object-side lens surface preferably does not protrude toward the object beyond the center of the lens surface, so that the length of the lens can be kept short. Thus, the first lens L1 closest to the object in the five lenses L1 to L5 needs to have a portion convex toward the object. The conditional expression (14) is for determining an appropriate range of a relationship between the focal length f of the entire imaging lens PL and the focal length fl of the first lens L1. A condition with a value that is larger than the upper limit value of the conditional expression (14) is unfavorable because it leads to a lens more on the image side than the aperture stop S having excessively high negative refractive power when the first lens L1 has the positive refractive power, rendering the correction of the coma aberration difficult and resulting in light falloff at edges. The first lens L1 having the negative refractive power is unfavorable because it leads to the back focus that is longer than necessary, resulting in a long length of the entire imaging lens.

To guarantee the effects of the present embodiment, the upper limit value of the conditional expression (14) is preferably set to be 0.25.

The imaging lens PL having the configuration described above preferably satisfies a condition indicated by the following conditional expression (15).

0.5<f2/f<0.7 (15)

where, f2 denotes a focal length of the second lens L2.

The conditional expression (15) is for determining an appropriate range of a relationship between the focal length f2 of the second lens L2 and the focal length f of the entire imaging lens PL. A condition with a value that is smaller than the lower limit value of the conditional expression (15) is unfavorable because it leads to the focal length f2 of the second lens L2 that is excessively short, rendering the correction of various aberrations, such as the spherical aberration and the coma aberration, difficult. A condition with a value that is larger than the upper limit value of the conditional expression (15) is unfavorable because it leads to the focal length f2 of the second lens L2 that is excessively long, resulting in a long length of the entire imaging lens.

To guarantee the effects of the present embodiment, the lower limit value of the conditional expression (15) is preferably set to be 0.55. To guarantee the effects of the present embodiment, the upper limit value of the conditional expression (15) is preferably set to be 0.65.

The imaging lens PL having the configuration described above preferably satisfies a condition indicated by the following conditional expressions (16) and (17).

−0.12<Y/(Fno×f1)<0.15 (16)

|f1/f23|>5 (17)

where, Y denotes a maximum image height of the imaging lens PL,

Fno denotes is an F number of the imaging lens PL, and

f1 denotes a focal length of the first lens L1.

The conditional expression (16) is for determining an appropriate range of a relationship among the maximum image height Y of the imaging lens PL, the F number Fno of the imaging lens PL, and the focal length f1 of the first lens L1. A condition with a value that is smaller than the lower limit value of the conditional expression (16) is unfavorable because it leads to the first lens L1 having excessively high negative refractive power leading to the back focus that is longer than necessary, resulting in a long length of the entire imaging lens. A condition with a value that is larger than the upper limit value of the conditional expression (16) is unfavorable because it leads to a lens more on the image side than the aperture stop S having excessively high negative refractive power when the positive refractive power of the first lens L1 is large, rendering the correction of the coma aberration difficult and resulting in light falloff at edges.

To guarantee the effects of the present embodiment, the lower limit value of the conditional expression (16) is preferably set to be −0.05. To guarantee the effects of the present embodiment, the upper limit value of the conditional expression (16) is preferably set to be 0.05.

The conditional expression (17) is for determining an appropriate range of a relationship between the focal length f1 of the first lens L1 and the combined focal length f23 of the second lens L2 and the third lens L3. A condition with a value that is smaller than the lower limit value of the conditional expression (17) is unfavorable because it results in the combined focal length f23 that needs to be short when the negative refractive power of the first lens L1 is excessively large, rendering the correction of the spherical aberration difficult. The condition is unfavorable because an incident angle of a lower side light flux incident on the second lens L2 is large when the positive refractive power of the first lens L1 is excessively large, rendering the correction of the coma aberration difficult.

To guarantee the effects of the present embodiment, the lower limit value of the conditional expression (17) is preferably set to be 10.0.

In the imaging lens PL having the configuration described above, as illustrated with the two-dot chain line in FIG. 1 for example, a bonded-multilayer diffractive optical element (DOE) may be provided on a lens surface of at least any one of the first lens L1, the second lens L2, and the third lens L3. With such a configuration, an on-axis chromatic aberration can be successfully corrected. As described above, the second embodiment can achieve a favorable imaging performance with the entire imaging lens PL having a short length.

In the embodiments described above, the image surface I has a curved shape to have a concave surface facing the object as illustrated in the figures referred to in Examples described below. The curved shape is a spherical shape in terms of manufacturing, but is not limited to the spherical shape, and an aspherical concave surface may be employed.

### EXAMPLE

### Example 1

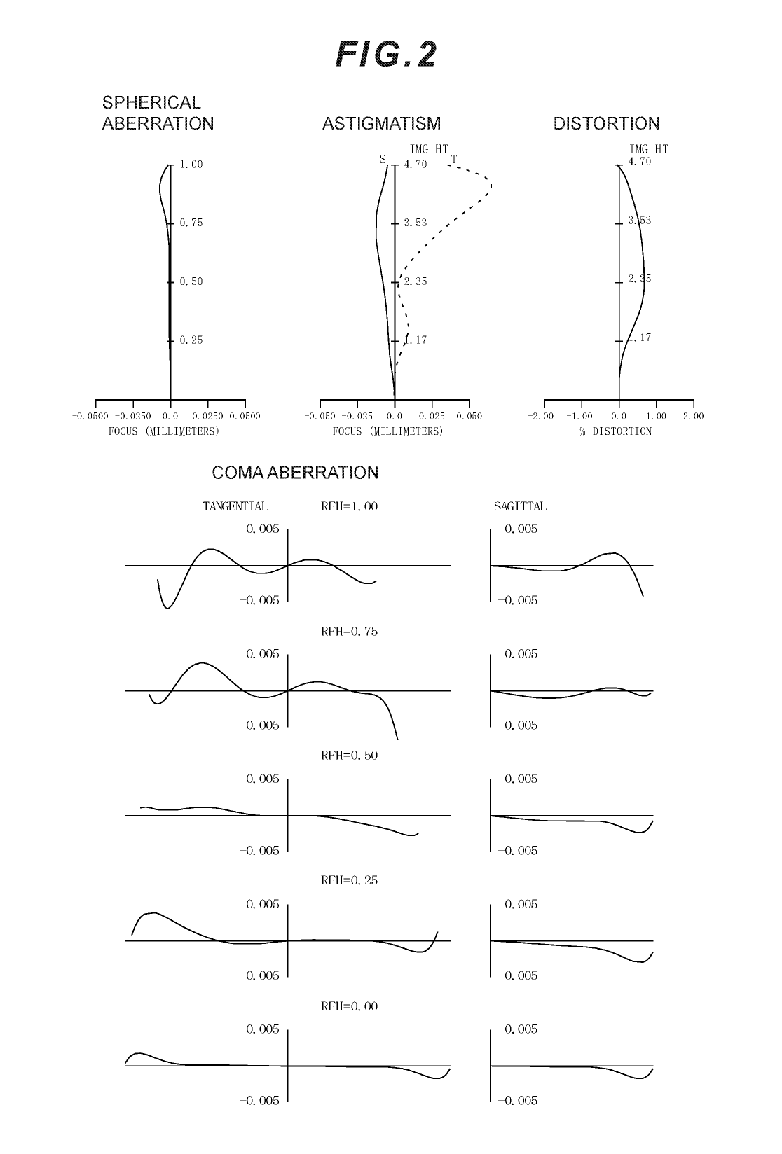

Examples according to the present application are described with reference to the drawings. First of all, Example 1 corresponding to the first embodiment and the second embodiment is described with reference to FIG. 1 and FIG. 2 and Table 1. FIG. 1 is a diagram illustrating a lens configuration of an imaging lens PL (PL1) according to Example 1. The imaging lens PL1 according to Example 1 includes: a first lens L1 having negative refractive power; a second lens L2 having positive refractive power; a third lens L3 having negative refractive power; a fourth lens L4 having positive refractive power; and a fifth lens L5 having negative refractive power which are disposed in order from the object along the optical axis Ax. The image surface I of the imaging lens PL1 is curved into a spherical shape to have a concave surface facing the object. A parallel flat plate CV, including a cover glass of the image sensor or the like, is disposed between the fifth lens L5 and the image surface I.

Both side lens surfaces of the first lens L1 are curved to have aspherical convex surfaces facing the object. An aperture stop S is provided, by insert molding, close to the image-side lens surface of the first lens L1. Both side lens surfaces of the second lens L2 are aspherical surfaces. Both side lens surfaces of the third lens L3 are aspherical surfaces. Both side lens surfaces of the fourth lens L4 are aspherical surfaces. Both side lens surfaces of the fifth lens L5 are aspherical surfaces.

Table 1 to Table 3 described below are tables illustrating specification values of imaging lenses according to Example 1 to Example 3. In the tables, [Overall specifications] includes values of the imaging lens PL such as: a focal length f; an F number Fno; half angle of view ω; and a maximum image height Y. In the tables, [Lens specifications] includes: a first column (surface number) indicating the number of a lens surface from the object; a second column R indicating a radius of curvature of the lens surface; a third column D indicating a distance to the next lens surface on the optical axis; a fourth column nd indicating a refractive index with respect to a d-line (wavelength λ=587.6 nm); and a fifth column vd indicating an Abbe number with respect to the d-line (wavelengthλ=587.6 nm). A mark * on the right of the first column (surface number) indicates that the lens surface is an aspherical surface. A radius of curvature “∞” indicates a flat surface, and a refractive index of air nd=1.000000 is omitted. A corresponding value of each conditional expression is written in [Conditional expression corresponding value].

An aspherical coefficient in [Aspherical data] is represented by the following formula (A), where Z denotes a distance (sag) from a lens surface vertex in the optical axis direction, h denotes the distance from the optical axis Ax, c denotes a curvature (reciprocal of the radius of curvature), k denotes a Korenich constant, and An denotes an nth (n=4, 6, 8, 10, 12, 14) aspherical coefficient. In each Example, a secondary aspherical coefficient A2 is 0, and is omitted. In [Aspherical data], “E-n” represents “×10⁻ⁿ”.

Z=(c×h²)/[1+{1−(1+k)×c²×h²}^{1/2}]+A4×h4+A6×h⁶+A8×h⁸+A10×h¹⁰+A12×h¹²+A14×h¹⁴ (_{A})

The focal length f, the radius of curvature R and the other units of length described below as the specification values, which are generally described with “mm” unless otherwise noted should not be construed in a limiting sense because the optical system proportionally expanded or reduced can have a similar or the same optical performance. In Example 2 and Example 3 described below, the same reference signs as in this Example are used.

In Table 1 below, specification values in Example 1 are listed. The radii of curvature R of 1st to 13th surfaces in Table 1 respectively correspond to reference numerals R1 to R13 denoting 1st to 13th surfaces in FIG. 1. In Example 1, 1st surface, 2nd surface, and 4th to 11th surfaces are aspherical lens surfaces.

TABLE 1
[Overall specifications]

| | |
|---|---|
| f | 5.853 |
| Fno | 2.0 |
| ω | 42.3° |
| Y | 4.7 |

[Lens specifications]

| Surface number | R | D | nd | νd |
|---|---|---|---|---|
| Object surface | ∞ | ∞ | | |
| 1* | 3.58814 | 0.60000 | 1.53500 | 55.73 |
| 2* | 2.99418 | 0.20000 | | |
| 3 | ∞ | 0.10000 | | (Aperture stop) |
| 4* | 3.59385 | 1.10000 | 1.59240 | 68.33 |
| 5* | −4.61425 | 0.05000 | | |
| 6* | −10.89554 | 0.60000 | 1.63970 | 23.52 |
| 7* | 30.11963 | 1.00000 | | |
| 8* | −8.47947 | 1.10000 | 1.53500 | 55.73 |
| 9* | −2.70651 | 0.20000 | | |
| 10* | 97.15970 | 0.60000 | 1.53500 | 55.73 |
| 11* | 2.57369 | 0.80000 | | |
| 12 | ∞ | 0.30000 | 1.51680 | 64.17 |
| 13 | ∞ | 1.00406 | | |
| Image surface | −18.57734 | | | |

[Aspherical data]

| | | | |
|---|---|---|---|
| 1st surface | | | |
| κ = 0.000000, | A4 = −1.905098E−02, | A6 = −3.925321E−03, | A8 = 2.940908E−05 |
| A10 = 8.107142E−05, | A12 = 0.000000E+00, | A14 = 0.000000E+00 | |
| 2nd surface | | | |
| κ = 0.000000, | A4 = −1.592238E−02, | A6 = −8.636819E−03, | A8 = 9.117990E−04 |
| A10 = 1.435611E−04, | A12 = 0.000000E+00, | A14 = 0.000000E+00 | |
| 4th surface | | | |
| κ = 0.000000, | A4 = 6.376984E−03, | A6 = −3.842839E−03, | A8 = 4.330670E−04 |
| A10 = −9.794193E−05, | A12 = −4.879042E−06, | A14 = 0.000000E+00 | |
| 5th surface | | | |
| κ = 0.000000, | A4 = −9.600867E−04, | A6 = −1.317960E−03, | A8 = 2.128628E−03 |
| A10 = −8.214733E−04, | A12 = 8.378415E−05, | A14 = 0.000000E+00 | |
| 6th surface | | | |
| κ = 0.000000, | A4 = −6.998459E−03, | A6 = 5.165677E−04, | A8 = 1.993257E−03 |
| A10 = −3.097902E−04, | A12 = 0.000000E+00, | A14 = 0.000000E+00 | |
| 7th surface | | | |
| κ = 0.000000, | A4 = −2.021762E−03, | A6 = 2.534751E−03, | A8 = −7.708647E−04 |
| A10 = 7.084518E−04, | A12 = −1.090781E−04, | A14 = 0.000000E+00 | |
| 8th surface | | | |
| κ = 0.000000, | A4 = 4.244460E−03, | A6 = −4.450262E−03, | A8 = 4.302994E−04 |
| A10 = −9.411797E−05, | A12 = 1.538679E−05, | A14 = 0.000000E+00 | |
| 9th surface | | | |
| κ = −10.060074, | A4 = −1.325119E−02, | A6 = 2.160387E−03, | A8 = −5.991852E−04 |
| A10 = 1.430015E−04, | A12 = −9.851887E−06, | A14 = 0.000000E+00 | |
| 10th surface | | | |
| κ = 0.000000, | A4 = −4.569543E−02, | A6 = 4.500491E−03, | A8 = 2.552752E−05 |
| A10 = −7.551026E−06, | A12 = −5.327296E−07, | A14 = 0.000000E+00 | |
| 11th surface | | | |
| κ = −11.216551, | A4 = −2.423316E−02, | A6 = 3.655799E−03, | A8 = −3.443295E−04 |
| A10 = 1.790314E−05, | A12 = −4.145952E−07, | A14 = 4.096204E−10 | |

[Conditional expression corresponding value]

Conditional expression (1) fc/f = 0.811
Conditional expression (2) SAG/fc = −0.127
Conditional expression (3) (ra + rb)/(ra − rb) = −0.469
Conditional expression (4) |f/fa| = 0.112
Conditional expression (5) fp/f = 0.613
Conditional expression (6) Y/(Fno fa) = −0.045
Conditional expression (7) |fa/fc| = 10.991
Conditional expression (11) f23/f = 0.811
Conditional expression (12) SAG/f23 = −0.127
Conditional expression (13) (r31 + r32)/(r31 − r32) = −0.469
Conditional expression (14) |f/f1| = 0.112
Conditional expression (15) f2/f = 0.613
Conditional expression (16) Y/(Fno × f1) = −0.045
Conditional expression (17) |f1/f23| = 10.991
Reference formula (B) f45/f = −3.412

As described above, the conditional expressions (1) to (7) and the conditional expressions (11) to (17) are all satisfied. The first lens L1 is one of the five lenses L1 to L5 that is closest to the object. The second lens L2 and the third lens L3 form one of sets, each including a positive lens and a negative lens disposed to the image side of the positive lens, having the largest positive refractive power as the combined refractive power. The third lens L3 is a negative lens formed of an optical material with an Abbe number of 40 or smaller. Thus, the conditional expression (1) is the same as the conditional expression (11), the conditional expression (2) is the same as the conditional expression (12), the conditional expression (3) is the same as the conditional expression (13), the conditional expression (4) is the same as the conditional expression (14), the conditional expression (5) is the same as the conditional expression (15), the conditional expression (6) is the same as the conditional expression (16), and the conditional expression (7) is the same as the conditional expression (17).

In a reference formula (B), f45 denotes the combined focal length of the fourth lens L4 and the fifth lens L5. The fourth lens L4 and the fifth lens L5 form one of sets, each including a positive lens and a negative lens disposed to the image side of the positive lens, not having the largest positive refractive power as the combined refractive power. Thus, it is indicated that the corresponding value of the reference formula (B) is not included within the range of the conditional expression (1).

FIG. 2 is graphs illustrating various aberrations of the imaging lens PL1 according to Example 1. In an aberration graph illustrating astigmatism, a solid line represents a sagittal image surface, and a broken line represents a meridional image surface. In an aberration graph illustrating the coma aberration, RFH denotes Relative Field Height. The description on the aberration graphs similarly applies to the other Examples.

It can be seen in the aberration graphs that in Example 1, various aberrations are successfully corrected and an excellent imaging performance is achieved. All things considered, the excellent imaging performance of the image capturing device CMR including the imaging lens PL1 according to Example 1 can be guaranteed.

### Example 2

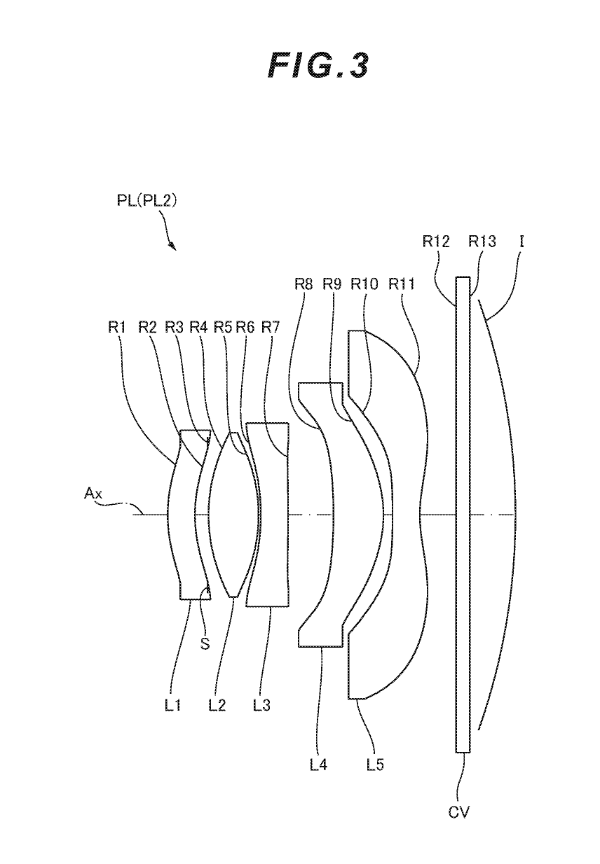

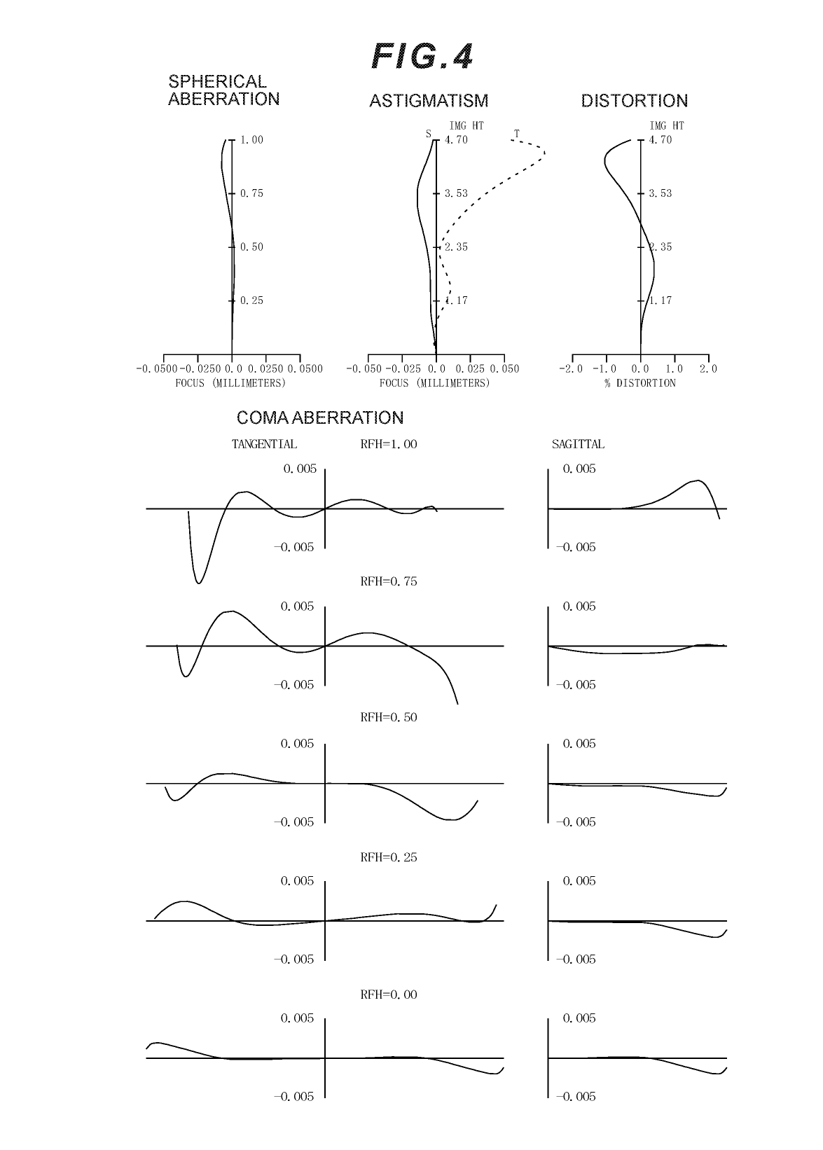

Next, Example 2 corresponding to the first embodiment and the second embodiment is described with reference to FIG. 3 and FIG. 4 and Table 2. FIG. 3 is a diagram illustrating a lens configuration of an imaging lens PL (PL2) according to Example 2. The imaging lens PL2 according to Example 2 includes: a first lens L1 having positive refractive power; a second lens L2 having positive refractive power; a third lens L3 having negative refractive power; a fourth lens L4 having positive refractive power; and a fifth lens L5 having negative refractive power which are disposed in order from the object along the optical axis Ax. The image surface I of the imaging lens PL2 is curved into a spherical shape to have a concave surface facing the object. A parallel flat plate CV, including a cover glass of the image sensor or the like, is disposed between the fifth lens L5 and the image surface I.

Both side lens surfaces of the first lens L1 are curved to have aspherical convex surfaces facing the object. An aperture stop S is provided, by insert molding, close to the image-side lens surface of the first lens L1. Both side lens surfaces of the second lens L2 are aspherical surfaces. Both side lens surfaces of the third lens L3 are aspherical surfaces. Both side lens surfaces of the fourth lens L4 are aspherical surfaces. Both side lens surfaces of the fifth lens L5 are aspherical surfaces.

In Table 2 below, specification values in Example 2 are listed. The radii of curvature R of 1st to 13th surfaces in Table 2 respectively correspond to reference numerals R1 to R13 denoting 1st to 13th surfaces in FIG. 3. In Example 2, 1st surface, 2nd surface, and 4th to 11th surfaces are aspherical lens surfaces.

TABLE 2
[Overall specifications]

| | |
|---|---|
| f | 5.868 |
| Fno | 2.0 |
| ω | 43.1° |
| Y | 4.7 |

[Lens specifications]

| Surface number | R | D | nd | νd |
|---|---|---|---|---|
| Object surface | ∞ | ∞ | | |
| 1* | 3.12316 | 0.60000 | 1.53500 | 55.73 |
| 2* | 3.05090 | 0.28000 | | |
| 3 | ∞ | 0.02000 | | (Aperture stop) |
| 4* | 3.56272 | 1.10000 | 1.53500 | 55.73 |
| 5* | −3.56250 | 0.05000 | | |
| 6* | −4.67268 | 0.60000 | 1.63970 | 23.52 |
| 7* | −42.90935 | 1.00000 | | |
| 8* | −9.78933 | 1.10000 | 1.53500 | 55.73 |
| 9* | −2.54179 | 0.20000 | | |
| 10* | −37.12583 | 0.60000 | 1.53500 | 55.73 |
| 11* | 2.83700 | 0.80000 | | |
| 12 | ∞ | 0.30000 | 1.51680 | 64.17 |
| 13 | ∞ | 1.00507 | | |
| Image surface | −13.99771 | | | |

[Aspherical data]

| | | | |
|---|---|---|---|
| 1st surface | | | |
| κ = 0.000000, | A4 = −1.213526E−02, | A6 = −2.914001E−03, | A8 = 7.340890E−05 |
| A10 = −1.382644E−04, | A12 = 0.000000E+00 | A14 = 0.000000E+00 | |
| 2nd surface | | | |
| κ = 0.000000, | A4 = −1.154281E−02, | A6 = −4.833499E−03, | A8 = 4.157969E−04 |
| A10 = −2.796214E−05, | A12 = 0.000000E+00 | A14 = 0.000000E+00 | |
| 4th surface | | | |
| κ = 0.000000, | A4 = 1.304745E−03, | A6 = −1.954684E−03, | A8 = 2.937754E−04 |
| A10 = −1.478835E−04, | A12 = 4.498558E−05, | A14 = 0.000000E+00 | |
| 5th surface | | | |
| κ = 0.000000, | A4 = −2.875187E−03, | A6 = −1.877794E−03, | A8 = 2.482260E−03 |
| A10 = −8.617318E−04, | A12 = 1.323289E−04, | A14 = 0.000000E+00 | |
| 6th surface | | | |
| κ = 0.000000, | A4 = −5.124018E−03, | A6 = 8.417598E−04, | A8 = 1.415639E−03 |
| A10 = −2.007317E−04, | A12 = 0.000000E+00 | A14 = 0.000000E+00 | |
| 7th surface | | | |
| κ = 0.000000, | A4 = 6.386856E−04, | A6 = 2.174683E−03, | A8 = −8.719897E−04 |
| A10 = 5.003192E−04, | A12 = −7.353934E−05, | A14 = 0.000000E+00 | |
| 8th surface | | | |
| κ = 0.000000, | A4 = 2.009774E−03, | A6 = −3.895257E−03, | A8 = 4.667208E−04 |
| A10 = −1.104665E−04, | A12 = 1.321651E−05, | A14 = 0.000000E+00 | |
| 9th surface | | | |
| κ = −7.856781, | A4 = −1.658180E−02, | A6 = 2.039827E−03, | A8 = −6.157134E−04 |
| A10 = 1.423582E−04, | A12 = −9.305220E−06, | A14 = 0.000000E+00 | |
| 10th surface | | | |
| κ = 0.000000, | A4 = −4.436982E−02, | A6 = 4.362051E−03, | A8 = 2.832907E−05 |
| A10 = −1.029337E−05, | A12 = −1.152115E−06, | A14 = 0.000000E+00 | |
| 11th surface | | | |
| κ = −12.819868, | A4 = −2.519875E−02, | A6 = 3.788695E−03, | A8 = −3.536631E−04 |
| A10 = 1.752252E−05, | A12 = −4.061527E−07, | A14 = 1.602396E−09 | |

[Conditional expression corresponding value]

Conditional expression (1) fc/f = 0.967
Conditional expression (2) SAG/fc = −0.143
Conditional expression (3) (ra + rb)/(ra − rb) = −1.244
Conditional expression (4) |f/fa| = 0.045
Conditional expression (5) fp/f = 0.600
Conditional expression (6) Y/(Fno × fa) = 0.018
Conditional expression (7) |fa/fc| = 22.922
Conditional expression (11) f23/f = 0.967
Conditional expression (12) SAG/f23 = −0.143
Conditional expression (13) (r31 + r32)/(r31 − r32) = −1.244
Conditional expression (14) |f/f1| = 0.045
Conditional expression (15) f2/f = 0.600
Conditional expression (16) Y/(Fno × f1) = −0.018
Conditional expression (17) |f1/f23| = 22.922
Reference formula (B) f45/f = −5.840

As described above, the conditional expressions (1) to (7) and the conditional expressions (11) to (17) are all satisfied. The first lens L1 is one of the five lenses L1 to L5 that is closest to the object. The second lens L2 and the third lens L3 form one of sets, each including a positive lens and a negative lens disposed to the image side of the positive lens, having the largest positive refractive power as the combined refractive power. The third lens L3 is a negative lens formed of an optical material with an Abbe number of 40 or smaller. Thus, the conditional expression (1) is the same as the conditional expression (11), the conditional expression (2) is the same as the conditional expression (12), the conditional expression (3) is the same as the conditional expression (13), the conditional expression (4) is the same as the conditional expression (14), the conditional expression (5) is the same as the conditional expression (15), the conditional expression (6) is the same as the conditional expression (16), and the conditional expression (7) is the same as the conditional expression (17).

The fourth lens L4 and the fifth lens L5 form one of sets, each including a positive lens and a negative lens disposed to the image side of the positive lens, not having the largest positive refractive power as the combined refractive power. Thus, it is indicated that the corresponding value of the reference formula (B) is not included within the range of the conditional expression (1).

FIG. 4 is graphs illustrating various aberrations of the imaging lens PL2 according to Example 2. It can be seen in the aberration graphs that in Example 2, various aberrations are successfully corrected and an excellent imaging performance is achieved. All things considered, the excellent imaging performance of the image capturing device CMR including the imaging lens PL2 according to Example 2 can be guaranteed.

### Example 3

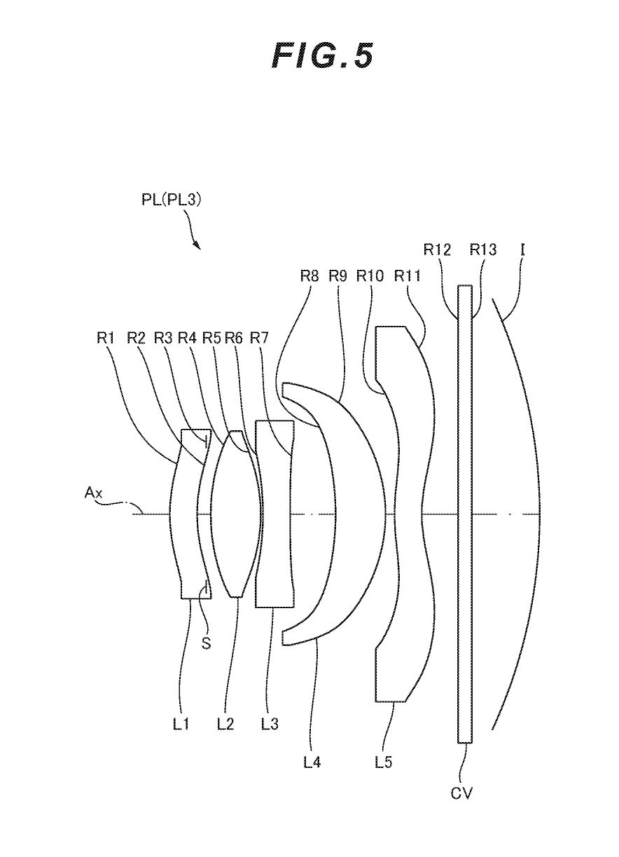

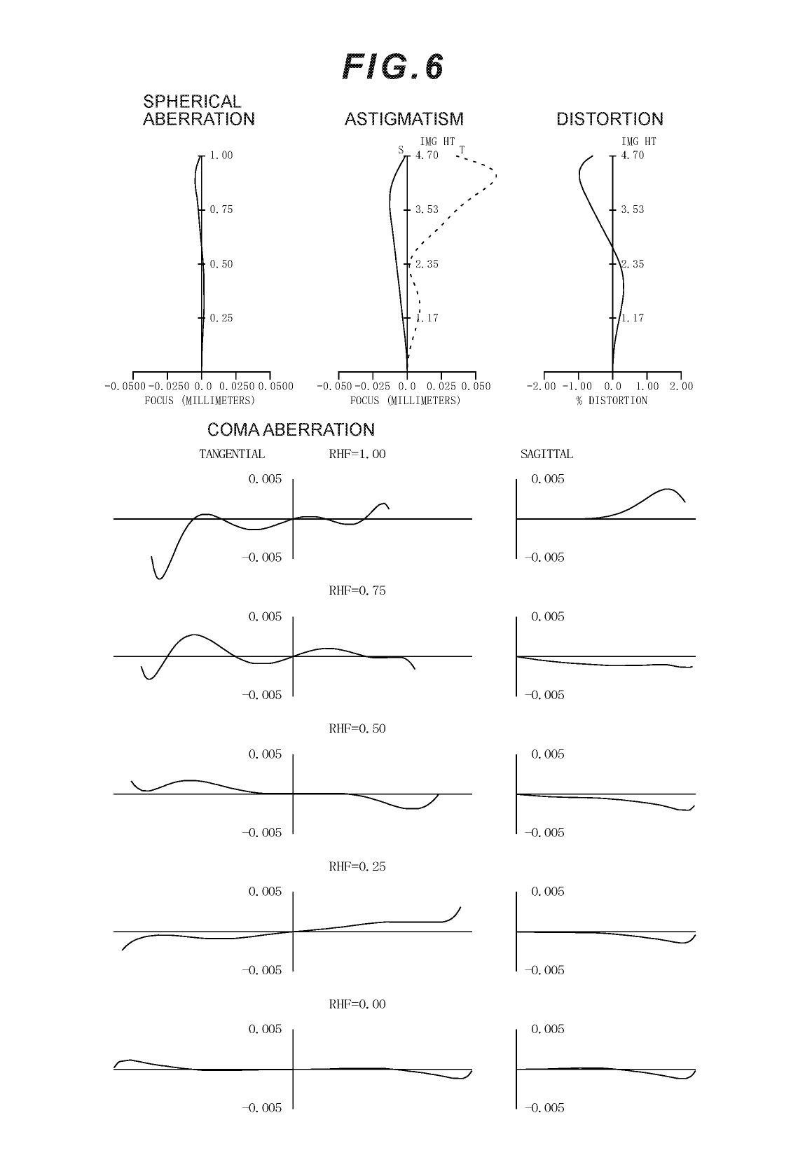

Next, Example 3 corresponding to the first embodiment and the second embodiment is described with reference to FIG. 5 and FIG. 6 and Table 3. FIG. 5 is a diagram illustrating a lens configuration of an imaging lens PL (PL3) according to Example 3. The imaging lens PL3 according to Example 3 includes: a first lens L1 having positive refractive power; a second lens L2 having positive refractive power; a third lens L3 having negative refractive power; a fourth lens L4 having positive refractive power; and a fifth lens L5 having negative refractive power which are disposed in order from the object along the optical axis Ax. The image surface I of the imaging lens PL3 is curved into a spherical shape to have a concave surface facing the object. A parallel flat plate CV, including a cover glass of the image sensor or the like, is disposed between the fifth lens L5 and the image surface I.

Both side lens surfaces of the first lens L1 are curved to have aspherical convex surfaces facing the object. An aperture stop S is provided, by insert molding, close to the image-side lens surface of the first lens L1. Both side lens surfaces of the second lens L2 are aspherical surfaces. Both side lens surfaces of the third lens L3 are aspherical surfaces. Both side lens surfaces of the fourth lens L4 are aspherical surfaces. Both side lens surfaces of the fifth lens L5 are aspherical surfaces.

In Table 3 below, specification values in Example 3 are listed. The radii of curvature R of 1st to 13th surfaces in Table 3 respectively correspond to reference numerals R1 to R13 denoting 1st to 13th surfaces in FIG. 5. In Example 3, 1st surface, 2nd surface, and 4th to 11th surfaces are aspherical lens surfaces.

TABLE 3
[Overall specifications]

| | |
|---|---|
| f | 5.912 |
| Fno | 2.0 |
| ω | 43.8° |
| Y | 4.7 |

[Lens specifications]

| Surface number | R | D | nd | νd |
|---|---|---|---|---|
| Object surface | ∞ | ∞ | | |
| 1* | 3.46239 | 0.60000 | 1.53500 | 55.73 |
| 2* | 3.37137 | 0.20000 | | |
| 3 | ∞ | 0.10000 | | (Aperture stop) |
| 4* | 4.13127 | 1.10000 | 1.53500 | 55.73 |
| 5* | −3.61119 | 0.05000 | | |
| 6* | −5.92015 | 0.60000 | 1.63970 | 23.52 |
| 7* | 55.55715 | 1.00000 | | |
| 8* | −5.64814 | 1.10000 | 1.53500 | 55.73 |
| 9* | −3.35055 | 0.20000 | | |
| 10* | 4.50000 | 0.60000 | 1.53500 | 55.73 |
| 11* | 3.00000 | 0.80000 | | |
| 12 | ∞ | 0.30000 | 1.51680 | 64.17 |
| 13 | ∞ | 1.49748 | | |
| Image surface | −11.08945 | | | |

[Aspherical data]

| | | | |
|---|---|---|---|
| 1st surface | | | |
| κ = 0.000000, | A4 = −1.043677E−02, | A6 = −2.424656E−03, | A8 = −1.490177E−04 |
| A10 = −6.686761E−05, | A12 = 0.000000E+00 | A14 = 0.000000E+00 | |
| 2nd surface | | | |
| κ = 0.000000, | A4 = −8.096253E−03, | A6 = −4.461763E−03, | A8 = 4.434949E−04 |
| A10 = −7.974020E−05, | A12 = 0.000000E+00 | A14 = 0.000000E+00 | |
| 4th surface | | | |
| κ = 0.000000, | A4 = 2.120646E−03, | A6 = −1.633784E−03, | A8 = 1.124988E−04 |
| A10 = 1.176972E−04, | A12 = −2.438439E−07, | A14 = 0.000000E+00 | |
| 5th surface | | | |
| κ = 0.000000, | A4 = 1.667268E−03, | A6 = −2.587821E−03, | A8 = 2.439766E−03 |
| A10 = −6.904527E−04, | A12 = 9.927198E−05, | A14 = 0.000000E+00 | |
| 6th surface | | | |
| κ = 0.000000, | A4 = −5.019878E−04, | A6 = −7.035886E−04, | A8 = 1.592027E−03 |
| A10 = −3.233124E−04, | A12 = 0.000000E+00 | A14 = 0.000000E+00 | |
| 7th surface | | | |
| κ = 0.000000, | A4 = 3.710473E−03, | A6 = 1.595928E−03, | A8 = −6.116918E−04 |
| A10 = 2.977347E−04, | A12 = −4.597579E−05, | A14 = 0.000000E+00 | |
| 8th surface | | | |
| κ = 0.000000, | A4 = 6.888376E−03, | A6 = −3.990456E−03, | A8 = 7.084014E−04 |
| A10 = −7.314271E−05, | A12 = −1.825776E−06, | A14 = 0.000000E+00 | |
| 9th surface | | | |
| κ = −5.819945, | A4 = −1.716600E−02, | A6 = 2.897915E−03, | A8 = −7.084160E−04 |
| A10 = 1.231249E−04, | A12 = −1.039563E−05, | A14 = 0.000000E+00 | |
| 10th surface | | | |
| κ = 0.000000, | A4 = −3.991829E−02, | A6 = 3.550748E−03, | A8 = −8.771361E−05 |
| A10 = −1.017952E−05, | A12 = 3.852730E−07, | A14 = 0.000000E+00 | |
| 11th surface | | | |
| κ = −3.550880, | A4 = −2.666443E−02, | A6 = 3.458725E−03, | A8 = −2.919526E−04 |
| A10 = 1.576851E−05, | A12 = −5.422026E−07, | A14 = 9.142382E−09 | |

[Conditional expression corresponding value]

Conditional expression (1) fc/f = 1.072
Conditional expression (2) SAG/fc = −0.165
Conditional expression (3) (ra + rb)/(ra − rb) = −0.807
Conditional expression (4) |f/fa| = 0.032
Conditional expression (5) fp/f = 0.641
Conditional expression (6) Y/(Fno × fa) = −0.013
Conditional expression (7) |fa/fc| = 29.137
Conditional expression (11) f23/f = 1.072
Conditional expression (12) SAG/f23 = −0.165
Conditional expression (13) (r31 + r32)/(r31 − r32) = −0.807
Conditional expression (14) |f/f1| = 0.032
Conditional expression (15) f2/f = 0.641
Conditional expression (16) Y/(Fno × f1) = 0.013
Conditional expression (17) |f1/f23| = 29.137
Reference formula (B) f45/f = 6.214

As described above, the conditional expressions (1) to (7) and the conditional expressions (11) to (17) are all satisfied. The first lens L1 is one of the five lenses L1 to L5 that is closest to the object. The second lens L2 and the third lens L3 form one of sets, each including a positive lens and a negative lens disposed to the image side of the positive lens, having the largest positive refractive power as the combined refractive power. The third lens L3 is a negative lens formed of an optical material with an Abbe number of 40 or smaller. Thus, the conditional expression (1) is the same as the conditional expression (11), the conditional expression (2) is the same as the conditional expression (12), the conditional expression (3) is the same as the conditional expression (13), the conditional expression (4) is the same as the conditional expression (14), the conditional expression (5) is the same as the conditional expression (15), the conditional expression (6) is the same as the conditional expression (16), and the conditional expression (7) is the same as the conditional expression (17).

The fourth lens L4 and the fifth lens L5 form one of sets, each including a positive lens and a negative lens disposed to the image side of the positive lens, not having the largest positive refractive power as the combined refractive power. Thus, it is indicated that the corresponding value of the reference formula (B) is not included within the range of the conditional expression (1).

FIG. 6 is graphs illustrating various aberrations of the imaging lens PL3 according to Example 3. It can be seen in the aberration graphs that in Example 3, various aberrations are successfully corrected and an excellent imaging performance is achieved. All things considered, the excellent imaging performance of the image capturing device CMR including the imaging lens PL3 according to Example 3 can be guaranteed.

With Examples described above, an imaging lens having a short entire length and a favorable imaging performance, and an image capturing device including the same can be implemented.

In Examples described above, the image surface I of the imaging lens PL is curved to have a spherical concave surface facing the object. However, this should not be construed in a limiting sense. For example, another curved shape such as an aspherical curved shape may be employed.

In Examples described above, the fourth lens L4 has positive refractive power. However, this should not be construed in a limiting sense, and the fourth lens L4 may have negative refractive power. The fifth lens L5 has negative refractive power. However, this should not be construed in a limiting sense, and the fifth lens L5 may have positive refractive power.

In Examples described above, the second lens L2 and the third lens L3 form one of the sets, each including a positive lens and a negative lens disposed to an image side of the positive lens, with the largest positive refractive power as the combined refractive power. However, this should not be construed in a limiting sense. The fourth lens L4 and the fifth lens L5 may form the set of positive and negative lenses with the largest positive refractive power as the combined refractive power.

In Examples described above, as illustrated with the two-dot chain line in FIG. 1 for example, a bonded-multilayer diffractive optical element (DOE) may be provided on a lens surface of at least one of the first lens L1, the second lens L2, and the third lens L3.

In Examples described above, the aperture stop S, disposed close to the first lens L1, is preferably disposed close to an image-side lens surface of the first lens L1 for the sake of aberration correction. The aperture stop may not be provided as a component, and its function may be achieved with a frame of a lens.

### EXPLANATION OF NUMERALS AND CHARACTERS

CMR image capturing device

SR image sensor

PL imaging lens

L1 first lens

L2 second lens

L3 third lens

L4 fourth lens

L5 fifth lens

S aperture stop

I image surface

DOE diffractive optical element

### RELATED APPLICATIONS

This is a continuation of PCT International Application No.PCT/JP2014/005968, filed on Nov. 28, 2014, which is hereby incorporated by reference.

1. An imaging lens having an image surface curved to have a concave surface facing an object, the imaging lens comprising five lenses including a positive lens and a negative lens,
wherein at least one negative lens in the five lenses is disposed to an image side of a positive lens, and
wherein a set of the positive lens and the negative lens, as one of sets each including the positive lens and the negative lens disposed to the image side of the positive lens, that has largest positive refractive power as combined refractive power, satisfies a following conditional expression:
0.5<fc/f<1.2, where
fc denotes a combined focal length of the positive lens and the negative lens with the largest positive refractive power as the combined refractive power, and
f denotes a focal length of the imaging lens.

2. The imaging lens according to claim 1, wherein a following conditional expression is satisfied
−0.3<SAG/fc<−0.09, where
SAG denotes an amount of curvature of the image surface in an optical axis direction at a maximum image height.

3. The imaging lens according to claim 2,
wherein the five lenses include at least one negative lens formed of an optical material with an Abbe number of 40 or smaller, and
wherein a following conditional expression is satisfied
(ra+rb)/(ra−rb)<0, where
ra denotes a radius of curvature of an object-side lens surface of the negative lens formed of the optical material with the Abbe number of 40 or smaller, and
rb denotes a radius of curvature of an image-side lens surface of the negative lens formed of the optical material with the Abbe number of 40 or smaller.

4. The imaging lens according to claim 3, wherein the negative lens formed of the optical material with the Abbe number of 40 or smaller is the negative lens in the set of lenses with the largest positive refractive power as the combined refractive power.

5. The imaging lens according to claim 4,
wherein a lens in the five lenses that is closest to the object has lens surfaces on both sides curved to have convex surfaces facing the object, and
wherein a following conditional expression is satisfied

|f/fa|<0.5, where
fa denotes a focal length of the lens closest to the object.

6. The imaging lens according to claim 1, wherein a following conditional expression is satisfied
0.5<fp/f<0.7, where
fp denotes a focal length of the positive lens in the set of lenses with the largest positive refractive power as the combined refractive power.

7. The imaging lens according to claim 1,
wherein a lens in the five lenses that is closest to the object has lens surfaces on both sides curved to have convex surfaces facing the object, and
wherein following conditional expressions are satisfied
−0.12<Y/(Fno×fa)<0.15 and

|fa/fc|>5, where
Y denotes a maximum image height of the imaging lens,
Fno denotes an F number of the imaging lens, and
fa denotes a focal length of the lens closest to the object.

8. The imaging lens according to claim 1,
wherein a lens in the five lenses that is closest to the object has lens surfaces on both sides curved to have convex surfaces facing the object, and
wherein a bonded-multilayer diffractive optical element is provided on a lens surface of at least one of the lens closest to the object, and the positive lens and the negative lens with the largest positive refractive power as the combined refractive power.

9. An imaging lens having an image surface curved to have a concave surface facing an object, the imaging lens comprising in order from the object:
a first lens having lens surfaces on both sides curved to have concave surfaces facing the object;
a second lens having positive refractive power;
a third lens having negative refractive power;
a fourth lens having positive refractive power or negative refractive power; and
a fifth lens having positive refractive power or negative refractive power,
wherein a following conditional expression is satisfied
0.5<f23/f<1.2, where
f23 denotes a combined focal length of the second lens and the third lens, and
f denotes a focal length of the imaging lens.

10. The imaging lens according to claim 9, wherein a following conditional expression is satisfied
−0.3<SAG/f23<−0.09, where
SAG denotes an amount of curvature of the image surface in an optical axis direction at a maximum image height.

11. The imaging lens according to claim 9, wherein a following conditional expression is satisfied
(r31+r32)/(r31−r32)<0, where
r31 denotes a radius of curvature of an object-side lens surface of the third lens, and
r32 denotes a radius of curvature of an image-side lens surface of the third lens.

12. The imaging lens according to claim 9, wherein a following conditional expression is satisfied

|f/f1|<0.5, where
f1 denotes a focal length of the first lens.

13. The imaging lens according to claim 9, wherein a following conditional expression is satisfied
0.5<f2/f<0.7, where
f2 denotes a focal length of the second lens.

14. The imaging lens according to claim 9, wherein a following conditional expression is satisfied
−0.12<Y/(Fno×f1)<0.15 and

|f1/f23|>5, where
Y denotes a maximum image height of the imaging lens,
Fno denotes an F number of the imaging lens, and
f1 denotes a focal length of the first lens.

15. The imaging lens according to claim 9, wherein a bonded-multilayer diffractive optical element is provided on a lens surface of at least one of the first lens, the second lens, and the third lens.

16. An image capturing device comprising:
an imaging lens with which an image of an object is formed on an imaging surface; and
an image sensor configured to obtain the image of the object formed on the imaging surface,
wherein the imaging lens comprises five lenses including a positive lens and a negative lens,
wherein at least one negative lens in the five lenses is disposed to an image side of a positive lens, and
wherein a set of the positive lens and the negative lens, as one of sets each including the positive lens and the negative lens disposed to the image side of the positive lens, that has largest positive refractive power as combined refractive power, satisfies a following conditional expression:
0.5<fc/f<1.2, where
fc denotes a combined focal length of the positive lens and the negative lens with the largest positive refractive power as the combined refractive power, and
f denotes a focal length of the imaging lens.

17. The image capturing device according to claim 16,
wherein the five lenses include at least one negative lens formed of an optical material with an Abbe number of 40 or smaller, and
wherein a following conditional expression is satisfied
(ra+rb)/(ra−rb)<0, where
ra denotes a radius of curvature of an object-side lens surface of the negative lens formed of the optical material with the Abbe number of 40 or smaller, and
rb denotes a radius of curvature of an image-side lens surface of the negative lens formed of the optical material with the Abbe number of 40 or smaller.

18. The image capturing device according to claim 17, wherein the negative lens formed of the optical material with the Abbe number of 40 or smaller is the negative lens in the set of lenses with the largest positive refractive power as the combined refractive power.

19. The image capturing device according to claim 16
wherein a lens in the five lenses that is closest to the object has lens surfaces on both sides curved to have convex surfaces facing the object, and
wherein a following conditional expression is satisfied

|f/fa|<0.5, where
fa denotes a focal length of the lens closest to the object.

20. The image capturing device according to claim 16, wherein a following conditional expression is satisfied
0.5<fp/f<0.7, where
fp denotes a focal length of the positive lens in the set of lenses with the largest positive refractive power as the combined refractive power.

21. The image capturing device according to claim 16,
wherein a lens in the five lenses that is closest to the object has lens surfaces on both sides curved to have convex surfaces facing the object, and
wherein following conditional expressions are satisfied
−0.12<Y/(Fno×fa)<0.15 and

|fa/fc|>5, where
Y denotes a maximum image height of the imaging lens,
Fno denotes an F number of the imaging lens, and
fa denotes a focal length of the lens closest to the object.

22. The image capturing device according to claim 16,
wherein a lens in the five lenses that is closest to the object has lens surfaces on both sides curved to have convex surfaces facing the object, and
wherein a bonded-multilayer diffractive optical element is provided on a lens surface of at least one of the lens closest to the object, and the positive lens and the negative lens with the largest refractive power as the combined refractive power.

23. The image capturing device according to claim 16,
wherein the imaging surface is curved to have a concave surface facing the object, and
wherein the image surface of the imaging lens is curved along the imaging surface.

24. The image capturing device according to claim 23, wherein a following conditional expression is satisfied
−0.3<SAG/fc<−0.09, where
SAG denotes an amount of curvature of the image surface in an optical axis direction at a maximum image height.
